(19) United States
(12) Patent Application Publication
(10) Pub. No.: US 2022/0040982 A1
(43) Pub. Date: Feb. 10, 2022

(54) HEAD CLEANING UNIT AND SUBSTRATE TREATING APPARATUS

(71) Applicant: SEMES CO., LTD., Chungcheongnam-do (KR)

(72) Inventors: Jae Hyun You, Cheonan-si (KR); Kyu Sang Youn, Cheonan-si (KR); Bong Hwan Park, Cheonan-si (KR)

(21) Appl. No.: 17/394,856

(22) Filed: Aug. 5, 2021

(30) Foreign Application Priority Data
Aug. 6, 2020 (KR) 10-2020-0098474

(51) Int. Cl. B41J 2/165

(52) U.S. Cl. CPC B41J 2/16526

(57) ABSTRACT

Disclosed is an inkjet head cleaning unit including a body, an ejection unit formed in the body, and that ejects a cleaning fluid for cleaning a nozzle surface of a head, a suction unit formed in the body, and that suctions the cleaning fluid used for cleaning the nozzle surface of the head and foreign substances separated from the nozzle surface of the head, and a central body provided between the ejection unit and the suction unit, and height of the central body is adjusted in a vertical direction.

### CROSS-REFERENCE TO RELATED APPLICATIONS

A claim for priority under 35 U.S.C. § 119 is made to Korean Patent Application No. 10-2020-0098474 filed on Aug. 6, 2020, in the Korean Intellectual Property Office, the entire contents of which are hereby incorporated by reference.

### BACKGROUND

Embodiments of the inventive concept described herein relate to a head cleaning unit and a substrate treating apparatus including the same, and more particularly, to a head cleaning unit that cleans a head that discharges a liquid in an inkjet manner, and a substrate treating apparatus including the same.

A liquid crystal display device that displays images includes two substrates, on which various thin films are deposited, and a liquid crystal layer interposed between the two substrates. In general, because the thin films formed on the substrates have patterns of various shapes, they are formed through deposition processes and photo etching processes for precision of the patterns. In this way, because the photo etching processes that use high-priced masks to form one thin film, manufacturing costs and manufacturing process time increase.

In recent years, a thin film forming method using an inkjet printing manner has been used as a measure for the thin film forming method. Because a thin film is formed by applying a chemical to a specific location of a substrate according to the inkjet printing manner, a separate etching process is not required. The inkjet printing manner may be used to form a color filter or an orientation film of a liquid crystal display device.

In general, the inkjet printing apparatus includes a head that applies a chemical onto a substrate, and a cleaning unit that cleans the head. The head includes a plurality of nozzles that discharges the chemical, and applies to a specific location of the substrate. In general, because the chemical used for the inkjet printing apparatus has a high viscosity and a high volatility, it is easily solidified. In particular, a chemical may reside around discharge holes of nozzles after the chemical is applied, and the residual chemical is solidified around the discharge holes to block the discharge holes of the nozzles or to be applied to the substrate when the chemical is applied, so that an uneven film may be formed.

### SUMMARY

Embodiments of the inventive concept provide a head cleaning unit that may remove fine liquid crystals that reside on a head certainly, and a substrate treating apparatus including the same.

Embodiments of the inventive concept also provide a head cleaning unit that may improve an efficiency of a head cleaning process, and a substrate treating apparatus including the same.

The technical objectives of the inventive concept are not limited to the above-mentioned ones, and the other unmentioned technical objects will become apparent to those skilled in the art from the following description.

According to an embodiment, an inkjet head cleaning unit includes a body, an ejection unit formed in the body, and that ejects a cleaning fluid for cleaning a nozzle surface of a head, a suction unit formed in the body, and that suctions the cleaning fluid used for cleaning the nozzle surface of the head and foreign substances separated from the nozzle surface of the head, and a central body provided between the ejection unit and the suction unit, and height of the central body is adjusted in a vertical direction.

Furthermore, a surface of the central body, which faces the nozzle surface of the head, may be a flat surface.

Furthermore, the inkjet head cleaning unit may further include an elevation device that elevate the central body.

Furthermore, the inkjet head cleaning unit may further include a measurement member that measures an interval between the nozzle surface of the head and the body or the central body, and a controller that controls the height of the central body.

Furthermore, the controller may control the height of the central body and whether the nozzle surface of the head is to be repeatedly cleaned depending on a residual ink state of the nozzle surface of the head.

Furthermore, the inkjet head cleaning unit may further include an imaging member that photographs the nozzle surface of the head, and the controller may receive information from the imaging member.

Furthermore, the body may include a first block provided on one side of the central body, and the ejection unit may be provided between the central body and the first block.

Furthermore, the ejection unit may include a vertical passage, through which the cleaning fluid flows in the vertical direction, and a discharge end formed at an end of the vertical passage, and that guides the cleaning fluid such that the cleaning fluid is ejected in a direction that faces the suction unit, and the discharge end may include a first curved surface formed on one side surface of the block, which faces one surface of the central body, to be curved toward the suction unit, and a second curved surface formed on the one surface of the central body to be curved toward the suction unit.

Furthermore, the body may include a second block provided on an opposite side of the central body, and the suction unit may be provided between the central body and the second block.

Furthermore, the inkjet head cleaning unit may further include an air providing unit that provides compressed air, a cleaning liquid providing unit that provides the cleaning liquid, and a mixing unit provided in the ejection unit, and that mixes the compressed air and the cleaning liquid, which are received from the air providing unit and the cleaning liquid providing unit, to generate a binary fluid.

According to another embodiment, an inkjet head cleaning unit includes a central body, a first block provided on one side of the central body, a second block provided on an opposite side of the central body, an ejection body formed between the first block and the central body, and that ejects a cleaning fluid for cleaning a nozzle surface of a head, a suction unit formed between the second block and the central body, and that suctions the cleaning fluid used for cleaning the nozzle surface of the head and foreign substances separated from the nozzle surface of the head, and a height of the central body is adjusted in a vertical direction.

Furthermore, an upper surface of the central body, which faces the nozzle surface of the head, may be a flat surface.

Furthermore, the inkjet head cleaning unit may further include a vision camera that photographs the nozzle surface of the head, and a controller that receives information from the vision camera.

Furthermore, the controller may control the height of the central body and whether the nozzle surface of the head is to be repeatedly cleaned depending on a residual ink state and a cleaning state of the nozzle surface of the head.

According to another embodiment, a liquid crystal applying apparatus includes a plurality of inkjet heads each having a nozzle surface that receives a liquid crystal and discharges the liquid crystal to an upper surface of a target, a driving unit that moves the inkjet heads in at least one direction, and a head cleaning unit that removes the liquid crystal that resides on the nozzle surface of each of the inkjet heads, the head cleaning unit includes a body, an ejection unit formed in the body, and that ejects a cleaning fluid for cleaning a nozzle surface of a head, a suction unit formed in the body, and that suctions the cleaning fluid used for cleaning the nozzle surface of the head and foreign substances separated from the nozzle surface of the head, and a central body provided between the ejection unit and the suction unit, and a height of the central body is adjusted in a vertical direction.

Furthermore, the liquid crystal applying apparatus may further include an elevation device that elevates the central body, a controller that controls the elevation device, and an imaging member that photographs the nozzle surface of the head and provide data corresponding to a result of the photographing to the controller.

Furthermore, a surface of the central body, which faces the nozzle surface of the head, may be a flat surface.

Furthermore, the controller may control the height of the central body and whether the nozzle surface of the head is to be repeatedly cleaned depending on a residual ink state and a cleaning state of the nozzle surface of the head.

Furthermore, the body may include a first block provided on one side of the central body, and a second block provided on an opposite side of the central body, the ejection unit may be formed between the first block and the central body, and the suction unit may be formed between the second block and the central body.

Furthermore, the ejection unit may include a vertical passage, through which the cleaning fluid flows in the vertical direction, and a discharge end formed at an end of the vertical passage, and that guides the cleaning fluid such that the cleaning fluid is ejected in a direction that faces the suction unit, and

Furthermore, the discharge end of the ejection unit may include a first curved surface formed on one side surface of the block, which faces one surface of the central body, to be curved toward the suction unit, and a second curved surface formed on the one surface of the central body to be curved toward the suction unit.

Furthermore, the inkjet head cleaning unit may include an air providing unit that provides compressed air, a cleaning liquid providing unit that provides a cleaning liquid, and a mixing unit that generates a binary fluid by mixing the compressed air and the cleaning liquid provided from the air providing unit and the cleaning providing unit.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a view illustrating a schematic configuration of a liquid crystal applying apparatus according to the inventive concept;

FIGS. 2 and 3 are views illustrating a configuration of an inkjet printing unit;

FIG. 4 is a perspective view illustrating a head cleaning apparatus;

FIG. 5 is a partially sectional perspective view of the head cleaning apparatus illustrated in FIG. 4;

FIGS. 6A and 6B are views illustrating a head cleaning process in a head cleaning apparatus;

FIG. 7 is a view illustrating a state, in which a central body is raised;

FIG. 8 is a view illustrating a state, in which a central body is lowered;

FIG. 9 is a view illustrating a first modification of the head cleaning apparatus; and

FIG. 10 is a view illustrating another example of an ejection unit.

### DETAILED DESCRIPTION

The inventive concept may be variously modified and may have various forms, and specific embodiments thereof will be illustrated in the drawings and described in detail. However, the embodiments according to the concept of the inventive concept are not intended to limit the specific disclosed forms, and it should be understood that the present inventive concept includes all transforms, equivalents, and replacements included in the spirit and technical scope of the inventive concept. In a description of the inventive concept, a detailed description of related known technologies may be omitted when it may make the essence of the inventive concept unclear.

The terminologies used herein are provided only to describe specific embodiments, and are not intended to limit the inventive concept. The terms of a singular form may include plural forms unless otherwise specified. The terms “including” and “having” are used to designate that the features, the numbers, the steps, the operations, the elements, the parts, or combination thereof described in the specification are present, and may be understood that one or more other features, numbers, step, operations, elements, parts, or combinations thereof may be added.

The terms such as first and second may be used to describe various elements, but the elements are not limited to the terms. The terms may be used only for the purpose of distinguishing one element from another element.

Hereinafter, embodiments of the inventive concept will be described with reference to the accompanying drawings, and in a description of the inventive concept, the same reference numerals are given to the same or corresponding elements regardless of the reference numerals and a repeated description thereof will be omitted.

Hereinafter, a facility that applies a treatment liquid to a target in an inkjet manner of discharging liquid droplets, and a method for applying a treatment liquid to a target by using the facility will be described.

For example, the target may be a color filter (CF) substrate or a thin film transistor (TFT) substrate of a liquid crystal display panel, and the treatment liquid may be a liquid crystal, an alignment liquid, an RGB ink, in which pigment particles are mixed. Polyimide may be used as the alignment liquid.

The alignment liquid may be applied onto a front surface of the color filter (CF) substrate or the thin film transistor (TFT) substrate, and the liquid crystal may be applied onto the front surface of the color filter (CF) substrate or the thin film transistor (TFT) substrate. The ink may be applied to an inner area of a black matrix, in which grid-shaped patterns are arranged, on the color filter (CF) substrate.

Although a facility that uses a liquid crystal as the treatment liquid will be described as an example in the present embodiment, the technical spirit of the inventive concept is not limited thereto.

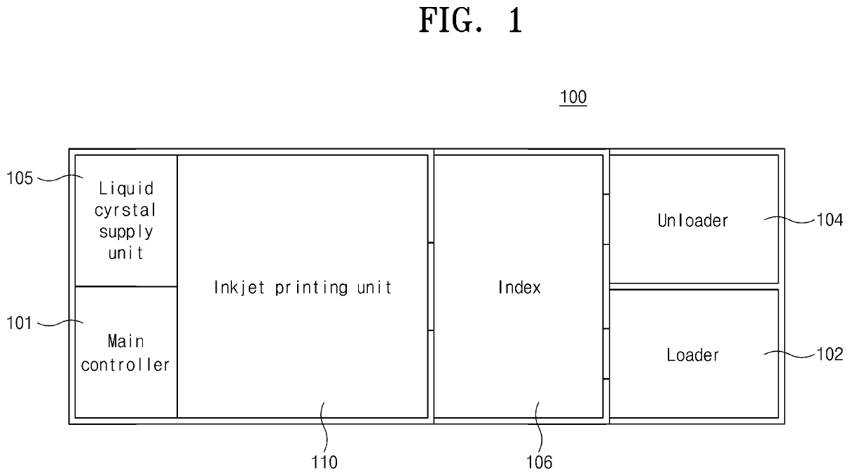

FIG. 1 is a view illustrating a schematic configuration of a liquid crystal applying apparatus according to the inventive concept.

Referring to FIG. 1, a liquid crystal applying apparatus 100 includes an inkjet printing unit 110 according to the inventive concept, as a facility that applies a liquid crystal onto an upper surface of a target (not illustrated) in an inkjet manner. The target includes a glass substrate for manufacturing a color filter, an alignment film, and the like of a rectangular panel, for example, a liquid crystal panel, a printed circuit board for forming a metallic thin film on a circuit pattern, and a plate for printing a liquid crystal in an inkjet manner. In the embodiment of the inventive concept, a glass substrate “S” for manufacturing a color filter will be described in detail as the target.

The liquid crystal applying apparatus 100 may include an inkjet printing unit 110 that prints a surface of a substrate in an inkjet manner, a loader 102, on which a plurality of substrates are loaded, an index 106 that extracts the substrates from the loader 102 to supply the extracted substrates to the inkjet printing unit 110, and an unloader 104 that unloads the substrates, on which a liquid crystal has been completely applied.

The index 106 may include a feeding robot (not illustrated) that feeds the substrates between the loader 102, the inkjet printing unit 110, and the unloader 104. The liquid crystal applying apparatus 100 includes a liquid crystal supply unit 105 that supplies the liquid crystal to the inkjet printing unit 110. Furthermore, the liquid crystal applying apparatus 100 includes a main controller 101 that controls an overall operation of the liquid crystal applying apparatus 100 as an electric part controller.

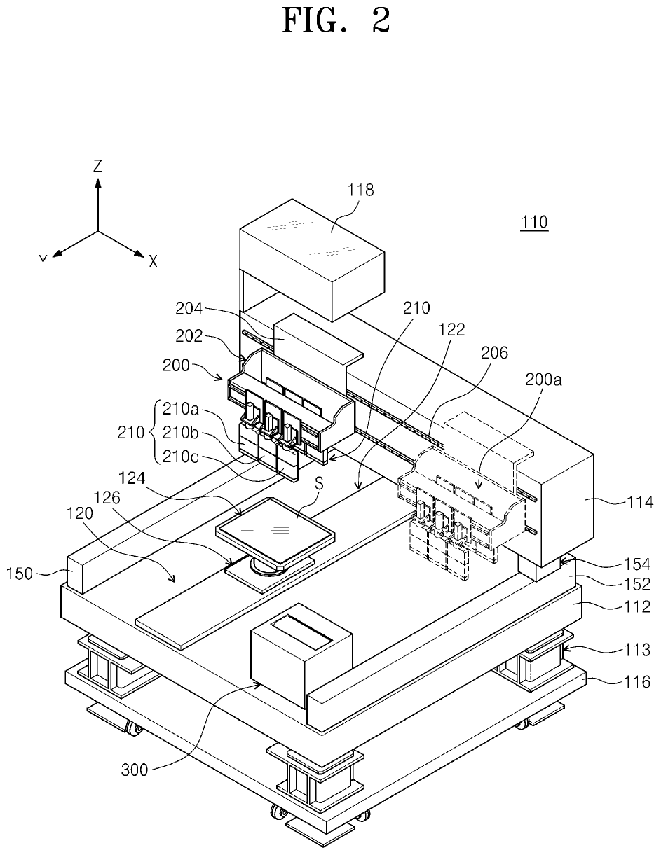

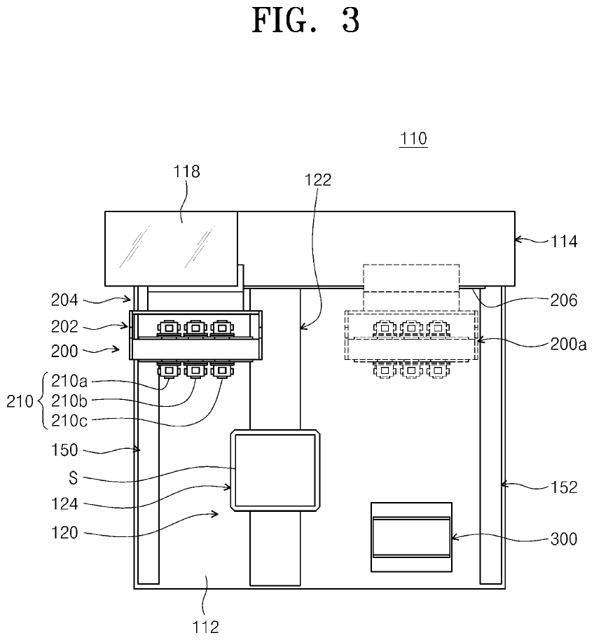

In detail, FIGS. 2 and 3 are views illustrating a configuration of an inkjet printing unit.

Referring to FIGS. 2 and 3, the inkjet printing unit 110 is an apparatus that applies the liquid crystal onto a surface of the substrate “S” in the inkjet manner, and may include a base 116 of a steel material, a stage 112 disposed on the base 116, a head assembly 200 disposed on the stage 112 and including a plurality of inkjet heads 210 that apply the liquid crystal onto the surface of the substrate “S” seated on the stage, and a gantry 114 that supports the head assembly 200. Furthermore, the inkjet printing unit 110 may include a plurality of anti-vibration members 113 for preventing vibration between the base 116 and the stage 112.

The head assembly 200 may be a multi-head array (MHA) unit. The head assembly 200 may include a plurality of inkjet heads 210 (210a to 210c) that discharge the liquid crystal in the inkjet manner, a bracket 202, in which the inkjet heads 210 are installed, and a driving unit 204 that is coupled to the bracket 202 to move the head assembly 200 in at least one direction.

A plurality of inkjet heads 210, for example, may be installed in two rows on front and rear surfaces of the bracket 202. That is, the plurality of inkjet heads 210 are disposed side by side on the front and rear surfaces of the bracket 202 in a Y axis direction. Each of the inkjet heads 210 is connected to a liquid crystal supply unit 105 (see FIG. 1) to receive the liquid crystal. The inkjet heads 210 may receive the same or different liquid crystals.

The inkjet head 210 is an apparatus that discharges the liquid onto a surface of the substrate “S”, and a head is provided at a lower end of each of the inkjet heads 210. The head has a nozzle surface provided with a plurality of nozzles (not illustrated) that supply the liquid crystal to the substrate “S”, on a lower surface thereof, which faces the surface of the substrate “S”. The nozzles discharge the liquid crystal to the substrate “S” individually.

When the target is the substrate “S” for color filters, the inkjet heads 210 supply any one of the liquid crystals of color “R”, color “G”, and color “B”. Then, the liquid crystals are inks of color “R”, color “G”, and color “B”. The inkjet heads 210 that supply the liquid crystals of color R, color G, and color B are disposed to be adjacent to each other.

The driving unit 204 includes first guide members 150 and 152 that are coupled to the bracket 202, in which the inkjet heads 210 are installed, to move the head assembly 200 in a first direction, a second guide member 206 that moves the head assembly 200 in a second direction, and a driver (not illustrated). The driving unit 204 is moved in the first direction (that is, the Y axis) or the second direction (that is, the X axis) along the gantry 114. Furthermore, the driving unit 204 moves the head assembly 204 in a third direction (that is, the Z axis). Furthermore, the driving unit 204 rotates the inkjet heads 210 bout central axes thereof.

The stage 112 is a surface table, and includes a chucking unit 120 that is disposed on one side of an upper side thereof to chuck the substrate “S”, and cleaning units 130 and 140 that disposed on an opposite side of the upper side thereof to clean the head assembly 200. The chucking unit 120 includes a chuck 124 that linearly moves toward the index 106 to receive the substrate “S”, chucks the substrate “S” when the substrate “S” is seated thereon, and moves to a location, at which the liquid crystal is to be applied onto the substrate “S”, a chuck driver 126 that moves the chuck 124 in at least one linear direction or rotates the chuck 124, and a third guide member 122 that guides the chuck 124 such that the chuck 124 moves linearly. A lower portion of the chuck 124 is coupled to the chuck driver 126 and the chuck 124 linearly moves along the third guide member 122 in the Y axis direction.

Furthermore, the first guide members 150 and 152 are installed in the stage 112 to correspond to opposite ends of the gantry 114. The first guide members 150 and 152 extend along the Y axis direction and have the same width as that of the stage 112. The first guide members 150 and 152 are provided long at opposite ends of the upper side of the stage 112 along the Y axis direction and linearly move the gantry 114 in the Y axis direction.

The driving unit 204 is coupled to one side surface of the gantry 114 and sliders 154 are coupled to lower portions of opposite sides of the gantry 114 so that the head assembly 200 is moved in the Y axis or X axis direction. To achieve this, the gantry 114 includes a second guide member 206 that linearly moves the head assembly 200 in the X axis direction, and a driving device (not illustrated) (for example, a motor, a gear, a pulley, a belt, a ball screw, and a linear motor) that drives the driving unit 204 such that the driving nit 204 is moved along the second guide member 206. A pressure controller 118 that controls an overall operation of the inkjet printing unit 110, for example, adjustment of pressure, supply of the liquid crystal, and discharge of the liquid crystal is installed on one side of the upper side of the gantry 114. The gantry 114 has the same width as that of the stage 112 in the X axis direction. That is, the sliders 154 are coupled to the opposite ends of the lower side of the gantry 114, and the slider 154 is moved in the Y axis direction along the first guide members 150 and 152. Furthermore, the gantry 114 linearly moves the driving unit 204 in the X axis direction such that the head assembly 200 is moved in the X axis direction.

Furthermore, the pressure controller 118 includes a meniscus pressure control (MPC) unit that adjusts an internal pressure of the inkjet head 210. The pressure controller 118 adjusts the internal pressure of the inkjet head 210 to a negative pressure, and individually controls a plurality of piezoelectric elements (not illustrated) to control the nozzles to uniformly discharge the liquid crystal when the liquid crystal is supplied.

In order to clean the inkjet head 210, the inkjet printing unit 110 moves the head assembly 200 to a location 200a corresponding to the cleaning unit.

The cleaning unit (maintenance zone) is provided with a head cleaning apparatus 300. The head cleaning apparatus 300 moves the inkjet head 210 in the Y axis direction such that the inkjet head 210 is located above a liquid crystal cleaning device when the head assembly 20 is moved in the X axis direction by the driving unit 204 and is moved to an opposite side of the stage 112. The inkjet head 210 is linearly moved while maintaining a specific interval from the liquid crystal cleaning device above the liquid crystal cleaning device whereby the liquid crystal that resides on the nozzle surfaces of the heads 210 is removed in a noncontact manner.

In this way, the head cleaning apparatus 300 may remove the liquid crystal that resides on the nozzle surfaces of the heads in the noncontact manner.

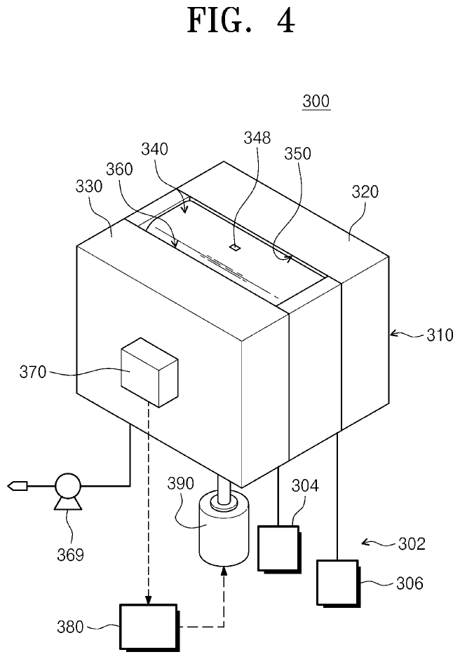

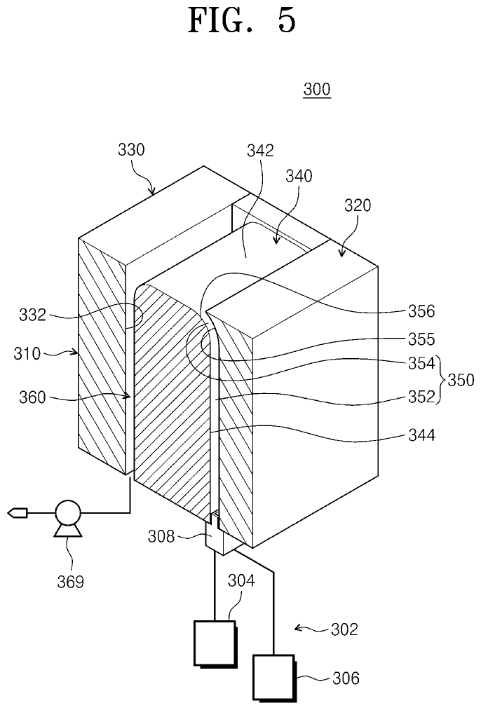

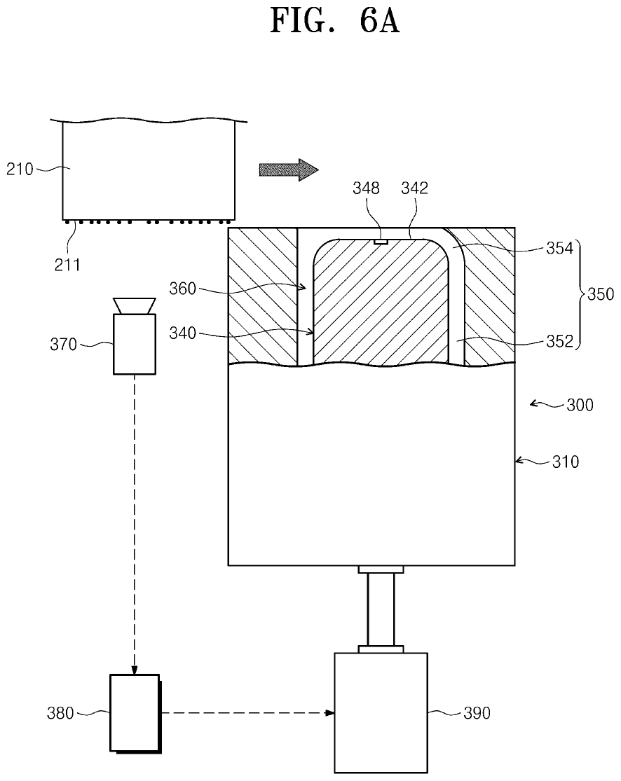

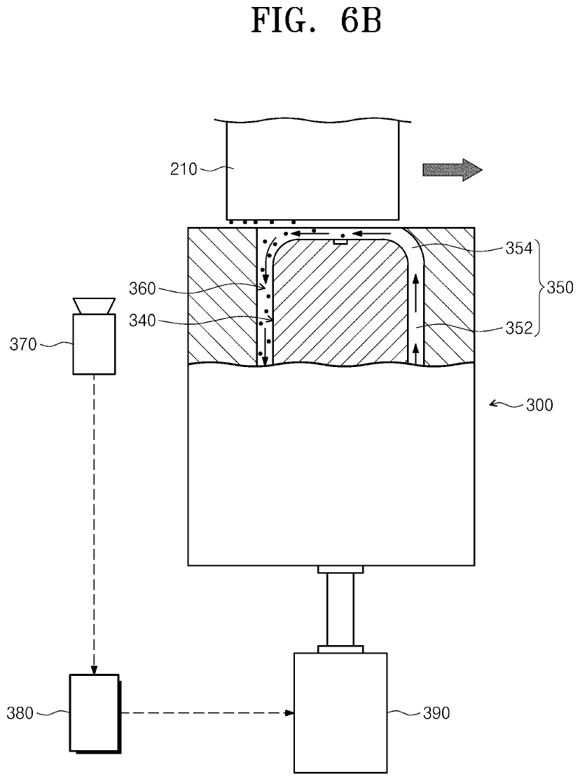

FIG. 4 is a perspective view illustrating a head cleaning apparatus. FIG. 5 is a partially sectional perspective view of the head cleaning apparatus illustrated in FIG. 4. FIGS. 6A and 6B are views illustrating a head cleaning process in a head cleaning apparatus.

Referring to FIGS. 4 to 6B, a head cleaning apparatus 300 may include a body 310, an ejection unit 350, a suction unit 360, an imaging member 370, and a controller 380.

The body 310 may include a first block 320, a second block 330, and a central body 340 provided therebetween. The ejection unit 350 and the suction unit 360 may be provided on the body 310.

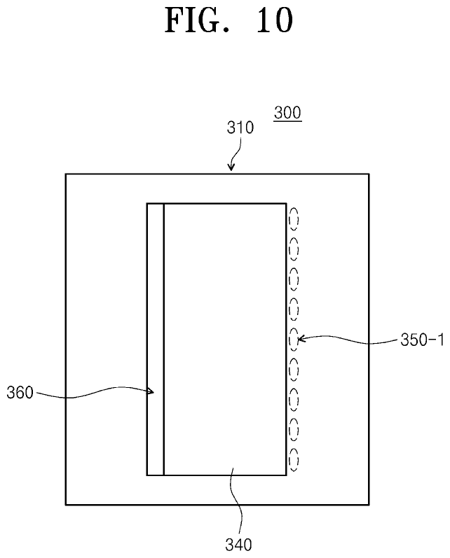

The ejection unit 350 may eject a cleaning fluid for removing foreign substances (residual liquid crystal) that reside on the nozzle surfaces 211 of the heads 210. The ejection unit 350 may be provided between the first block 320 and the central body 340 in a form of a slot. The ejection unit 350 may include a vertical passage 352, and a discharge end 354 formed at an end of the vertical passage 352. The cleaning fluid may be supplied through a cleaning fluid supply unit 302 connected to a lower end of the vertical passage 352, and the cleaning fluid may be ejected to an upper surface of the central body 340 through the discharge end 354 after passing through the vertical passage 352. Although it is illustrated in the present embodiment that the ejection unit 350 is formed in the form of the slot, the inventive concept is not limited thereto, but as illustrated in FIG. 10, an ejection unit 350-1 may be formed in a form of a hole.

The discharge end 354 may guide the cleaning fluid such that the cleaning fluid is ejected in a direction that faces the suction unit 360. As an example, the discharge end 354 includes a first curved surface 355 formed on one side surface (a side surface that faces the central body) of the first block 320 to be curved toward the suction unit 360, and a second curved surface 356 formed on one side surface 344 of the central body 340 to be curved toward the suction unit 360.

The cleaning fluid supply unit 302 may supply the compressed air and the cleaning liquid to the ejection unit 350. The compressed air may be provided through an air providing unit 304. The cleaning liquid may be provided through a cleaning liquid providing unit 306. The compressed air and the cleaning liquid provided from the air providing unit 304 and the cleaning liquid providing unit 306 may be mixed in a mixing unit 308 and may be provided to the ejection unit 350 in a form of a binary fluid. The mixing unit 308 may selectively provide the compressed air and the cleaning liquid.

The suction unit 360 may be formed on the body 310. The suction unit 360 may suction the cleaning fluid that is ejected by the ejection unit 350 and is used for cleaning the nozzle surfaces 211, and foreign substances removed from the nozzle surfaces 211 of the heads. The suction unit 360 may be provided between the central body 340 and the second block 330 in a form of a slot. The suction unit 360 is formed such that an inner surface 332 of the second block 330 is vertical. Here, the inner surface 332 of the second block 330 corresponds to an opposite surface (a side surface that faces the central body 340) to a direction, in which the cleaning fluid is supplied. A vacuum pump 369 may provide a suction force to the suction unit 360.

Meanwhile, it is characterized that an upper surface 342 of the central body 340, which faces the nozzle surface 211 of the head 210, is a flat surface. The central body 340 having the structure is characterized in that the cleaning fluid may flow horizontally without being spread out (turbulent) by forming a straight passage (the passage through which the cleaning fluid passes) having flat upper and lower sides with the nozzle surface 211 of the head 210 and the upper surface 342 of the central body 340 until the cleaning fluid ejected by the ejection unit 350 is exhausted to the suction unit 360.

The central body 340 may be installed on the body such that a height thereof may be adjusted. The central body 340 may be elevated by an elevation device 390.

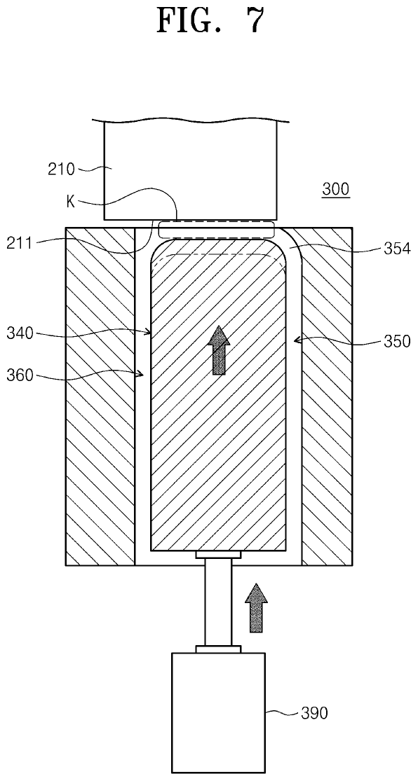

FIG. 7 is a view illustrating a state, in which a central body is raised.

As in FIG. 7, when the central body 340 is raised, a cross-sectional area of a passage “K”, through which the cleaning fluid between the nozzle surfaces 211 of the head 210 and the upper surface 342 of the central body 340 may decrease, and a size of the discharge end 354 of the ejection unit 350 may decrease. Accordingly, the flow velocity of the cleaning fluid ejected by the ejection unit 350 and the cleaning fluid that passes through the passage may become higher.

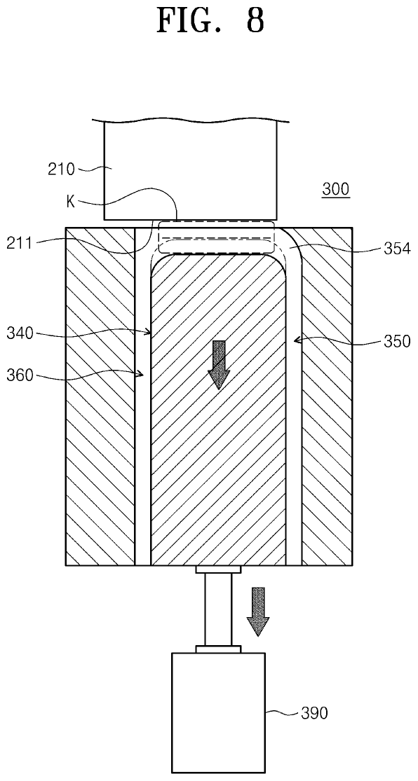

FIG. 8 is a view illustrating a state, in which a central body is lowered.

Referring to FIG. 8, when the central body 340 is lowered, a cross-sectional area of the passage between the nozzle surface 211 and the upper surface 342 of the central body 340, through which the cleaning fluid passes, and the discharge end 354 increase. Accordingly, the flow velocity of the cleaning fluid that passes through the passage (the discharge end) may become lower.

Meanwhile, an interval between the nozzle surface 211 and the central body (body) 340 may be measured through sensing of a measurement member 348. As an example, the measurement member 348 may be provided on an upper surface of the body (the upper surface of the central body). Data measured by the measurement member 348 may be provided to the controller 380. The controller 380 may receive the data provided by the measurement member 348 and adjust the height of the central body 340.

For example, the controller 380 may adjust the interval between the central body 340 and the nozzle surface 211 depending on a type (viscosity) of the ink discharged from the head 210, an amount of the residual ink on the nozzle surface, and a size of the residual ink. For example, when the amount of the ink that resides on the nozzle surface 211 is large or the size of the residual ink is large, the head may be cleaned in a state, in which the central body 340 is lowered and the interval between the central body 340 and the nozzle surface 211 is widened.

As described above, the head cleaning apparatus 300 of the inventive concept may adjust a height between the central body 340 and the head 210 to improve cleaning efficiency. Furthermore, a height of the head cleaning apparatus 300 of the inventive concept may be set to an optimum height such that the central body 340 may be raised to a setting location to perform a cleaning operation when the head 210 is located above the head cleaning apparatus 300.

The imaging member 370 may photograph the nozzle surface 211. The imaging member 370 may provide the captured data to the controller 380. As an example, the imaging member 370 may be a vision camera. The imaging member 370 may photograph the nozzle surface 211 of the head 210 before and after the cleaning operation of the head cleaning apparatus 300. The controller 380 may receive the information captured by the imaging member 370 and identify the residual ink of the head 210, and may increase the cleaning efficiency by determining a vertical movement distance of the central body 340 and whether the cleaning operation is to be repeated. For example, the controller 380 may control to perform a cleaning operation again when the residual ink of the head 210 which has been cleaned by the head cleaning apparatus 300 is not perfectly removed.

The head cleaning apparatus 300 having the above configuration may minimize an impact generated while the cleaning fluid is directly ejected onto the nozzle surface 211 at an angle that is almost vertical (or an oblique angle that is close to a vertical direction) and prevent a damage to the nozzle surface 211 due to the impact by ejecting the cleaning fluid at an angle that is almost close to the nozzle surface 211 of the head 210 (a low angle).

Furthermore, cleaning efficiency may be improved by separating the ink that resides on the nozzle surface of the head with a prompt and strong pressure through the binary fluid, in which the compressed air and the cleaning liquid are mixed.

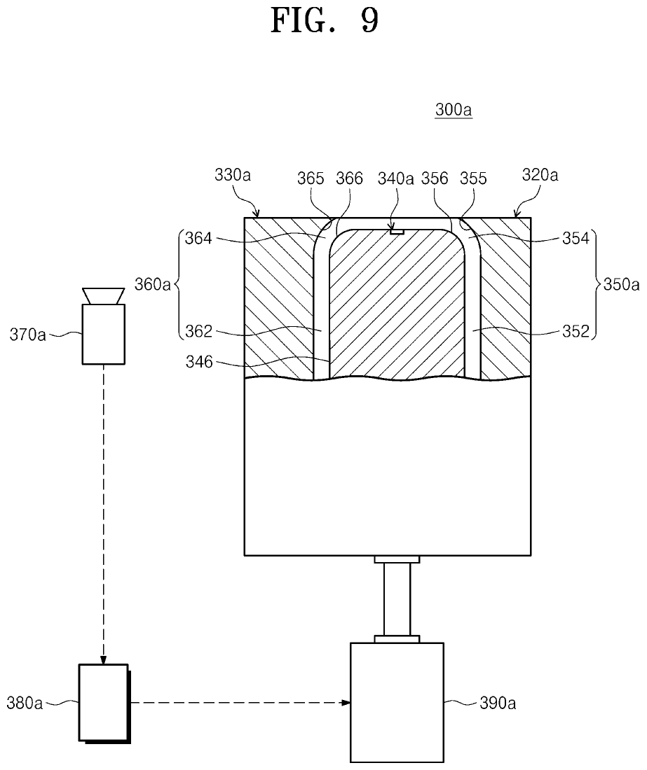

FIG. 9 is a view illustrating a first modification of the head cleaning apparatus.

As illustrated in FIG. 9, a head cleaning apparatus 300a according to the modification includes a body 310a, a first block 320a, a second block 330a, a central body 340a, an ejection unit 350, and a suction unit 360, which have substantially similar configurations and functions as those of the body 310, the first block 320, the second block 330, the central body 340, the ejection unit 350, and the suction unit 360 illustrated in FIG. 5, and thus a difference between the modification and the present embodiment will be mainly described.

In the modification, the difference lies in that an inlet (introduction end) of the suction unit 360 is curved toward the ejection unit. The suction unit 360 includes an exhaust passage 362 that is perpendicular to the inlet 364, and the inlet 364 includes a third curved surface 365 of an inner surface of the second block 330a (a side surface that faces the central body) and a fourth surface 366 of an opposite surface 346 of the central body 340. The third curved surface 365 and the fourth curved surface 366 may be formed to be curved toward the ejection unit 360.

In this way, the cleaning fluid used for cleaning the nozzle surface of the head and the foreign substances separated from the nozzle surface of the head may be stably exhausted through the curved inlet 364 of the suction unit 360a.

The head cleaning unit and the substrate treating apparatus including the same according to the embodiments of the inventive concept may perfectly remove fine liquid crystals that reside on the head.

The head cleaning unit and the substrate treating apparatus including the same according to the embodiments of the inventive concept may improve an efficiency of the head cleaning process.

According to the embodiments of the inventive concept, a damage to the nozzle surface by the cleaning fluid may be prevented.

According to the embodiments of the inventive concept, because the ink that resides on the nozzle surface of the head may be easily separated by a prompt and strong pressure through a binary fluid, in which compressed air and the cleaning liquid are mixed, cleaning efficiency may be improved.

The effects of the inventive concept are not limited to the above-described ones. Unmentioned effects will be clearly understood from the specification and the accompanying drawings by those skilled in the art to which the inventive concept pertains.

The above description is a simple exemplification of the technical spirits of the inventive concept, and the inventive concept may be variously corrected and modified by those skilled in the art to which the inventive concept pertains without departing from the essential features of the inventive concept. Accordingly, the embodiments disclosed in the inventive concept is not provided to limit the technical spirits of the inventive concept but provided to describe the inventive concept, and the scope of the technical spirits of the inventive concept is not limited by the embodiments. Accordingly, the genuine technical scope of the inventive concept should be construed by the attached claims, and all the technical spirits within the equivalent ranges fall within the scope of the inventive concept.

What is claimed is:

1. An inkjet head cleaning unit comprising:
a body;
an ejection unit formed in the body, and configured to eject a cleaning fluid for cleaning a nozzle surface of a head;
a suction unit formed in the body, and configured to suction the cleaning fluid used for cleaning the nozzle surface of the head and foreign substances separated from the nozzle surface of the head; and
a central body provided between the ejection unit and the suction unit,
wherein a height of the central body is adjusted in a vertical direction.

2. The inkjet head cleaning unit of claim 1, wherein a surface of the central body, which faces the nozzle surface of the head, is a flat surface.

3. The inkjet head cleaning unit of claim 1, further comprising:
an elevation device configured to elevate the central body.

4. The inkjet head cleaning unit of claim 3, further comprising:
a measurement member configured to measure an interval between the nozzle surface of the head and the body or the central body; and
a controller configured to control the height of the central body.

5. The inkjet head cleaning unit of claim 4, wherein the controller controls the height of the central body and whether the nozzle surface of the head is to be repeatedly cleaned depending on a residual ink state of the nozzle surface of the head.

6. The inkjet head cleaning unit of claim 4, further comprising:
an imaging member configured to photograph the nozzle surface of the head,
wherein the controller receives information from the imaging member.

7. The inkjet head cleaning unit of claim 1, wherein the body includes:
a first block provided on one side of the central body, and
wherein the ejection unit is provided between the central body and the first block.

8. The inkjet head cleaning unit of claim 7, wherein the ejection unit includes:
a vertical passage, through which the cleaning fluid flows in the vertical direction; and
a discharge end formed at an end of the vertical passage, and configured to guide the cleaning fluid such that the cleaning fluid is ejected in a direction that faces the suction unit, and
wherein the discharge end includes:
a first curved surface formed on one side surface of the block, which faces one surface of the central body, to be curved toward the suction unit; and
a second curved surface formed on the one surface of the central body to be curved toward the suction unit.

9. The inkjet head cleaning unit of claim 1, wherein the body includes:
a second block provided on an opposite side of the central body, and
wherein the suction unit is provided between the central body and the second block.

10. The inkjet head cleaning unit of claim 1, further comprising:
an air providing unit configured to provide compressed air;
a cleaning liquid providing unit configured to provide the cleaning liquid; and
a mixing unit provided in the ejection unit, and configured to mix the compressed air and the cleaning liquid, which are received from the air providing unit and the cleaning liquid providing unit, to generate a binary fluid.

11. An inkjet head cleaning unit comprising:
a central body;
a first block provided on one side of the central body;
a second block provided on an opposite side of the central body;
an ejection body formed between the first block and the central body, and configured to eject a cleaning fluid for cleaning a nozzle surface of a head; and
a suction unit formed between the second block and the central body, and configured to suction the cleaning fluid used for cleaning the nozzle surface of the head and foreign substances separated from the nozzle surface of the head,
wherein a height of the central body is adjusted in a vertical direction.

12. The inkjet head cleaning unit of claim 11, wherein an upper surface of the central body, which faces the nozzle surface of the head, is a flat surface.

13. The inkjet head cleaning unit of claim 11, further comprising:
a vision camera configured to photograph the nozzle surface of the head; and
a controller configured to receive information from the vision camera.

14. The inkjet head cleaning unit of claim 13, wherein the controller controls the height of the central body and whether the nozzle surface of the head is to be repeatedly cleaned depending on a residual ink state and a cleaning state of the nozzle surface of the head.

15. A liquid crystal applying apparatus comprising:
a plurality of inkjet heads each having a nozzle surface that receives a liquid crystal and discharges the liquid crystal to an upper surface of a target;
a driving unit configured to move the inkjet heads in at least one direction; and
a head cleaning unit configured to remove the liquid crystal that resides on the nozzle surface of each of the inkjet heads,
wherein the head cleaning unit includes:
a body;
an ejection unit formed in the body, and configured to eject a cleaning fluid for cleaning a nozzle surface of a head;
a suction unit formed in the body, and configured to suction the cleaning fluid used for cleaning the nozzle surface of the head and foreign substances separated from the nozzle surface of the head; and
a central body provided between the ejection unit and the suction unit, and
wherein a height of the central body is adjusted in a vertical direction.

16. The liquid crystal applying apparatus of claim 15, further comprising:
an elevation device configured to elevate the central body;
a controller configured to control the elevation device; and
an imaging member configured to photograph the nozzle surface of the head and provide data corresponding to a result of the photographing to the controller.

17. The liquid crystal applying apparatus of claim 15, wherein a surface of the central body, which faces the nozzle surface of the head, is a flat surface.

18. The liquid crystal applying apparatus of claim 16, wherein the controller controls the height of the central body and whether the nozzle surface of the head is to be repeatedly cleaned depending on a residual ink state and a cleaning state of the nozzle surface of the head.

19. The liquid crystal applying apparatus of claim 15, wherein the body includes:
a first block provided on one side of the central body; and
a second block provided on an opposite side of the central body,
wherein the ejection unit is formed between the first block and the central body, and
wherein the suction unit is formed between the second block and the central body.

20. The liquid crystal applying apparatus of claim 19, wherein the ejection unit includes:
a vertical passage, through which the cleaning fluid flows in the vertical direction; and
a discharge end formed at an end of the vertical passage, and configured to guide the cleaning fluid such that the cleaning fluid is ejected in a direction that faces the suction unit, and
wherein the discharge end of the ejection unit includes:
a first curved surface formed on one side surface of the block, which faces one surface of the central body, to be curved toward the suction unit; and
a second curved surface formed on the one surface of the central body to be curved toward the suction unit.
